(19) United States
(12) Patent Application Publication
(10) Pub. No.: US 2025/0330475 A1
(43) Pub. Date: Oct. 23, 2025

(54) SYSTEM AND METHOD FOR PROVIDING SERVICE ON BASIS OF USER NETWORK PROFILE

(71) Applicant: AWESOMEBLY, INC., Seoul (KR)

(72) Inventors: Kyungsik KIM, Gwangmyeong-si (KR); Mun Hwan BAE, Siheung-si (KR)

(21) Appl. No.: 19/254,034

(22) Filed: Jun. 30, 2025

Related U.S. Application Data
(63) Continuation of application No. PCT/KR2024/000068, filed on Jan. 2, 2024.

(30) Foreign Application Priority Data
Dec. 30, 2022 (KR) 10-2022-0191195
May 25, 2023 (KR) 10-2023-0067945
Jan. 2, 2024 (KR) 10-2024-0000176

(51) Int. Cl. H04L 9/40; H04L 12/66; H04L 67/306

(52) U.S. Cl. CPC H04L 63/108; H04L 12/66; H04L 63/0807; H04L 63/0876; H04L 63/102; H04L 67/306

(57) ABSTRACT

Disclosed is a service provision system based on a user network profile including a user terminal for a user to request a service and use the service provided from a service server, an access control server configured to provide the user network profile, which is information necessary to use the service, to the user, and to control access to the service server by the user, and a gateway configured to relay data provided from the service server to the user terminal between the user terminal and the service server, and a service is provided without exposing an address of the service server.

### TECHNICAL FIELD

The present invention relates to a service provision system using a user network, and more particularly to a service provision system capable of preventing information exposure of a server through reverse connection with a dynamic port based on a user network profile at a gateway that relays data between a user and the server.

### BACKGROUND ART

Recently, due to advancement of information and communication technology, development of information provision technology has been actively conducted to provide information on various fields in real time to a large number of subscribers through at least one service provision server via a data communication network.

Meanwhile, information security technology has been actively developed so that, when a user attempts to access the service provision server using a computer terminal to perform communication, the service provision server serves as a protected server, and a security system is applied thereto to protect the service provision server by a security server.

In addition, in order to secure access to in-house information servers, etc. used in corporations or financial institutions, permissions need to be restricted in detail by user, task, or role, and loop-around connection needs to be blocked.

In general, when a user requests access using a specific protocol such as SSH (secure shell), TELNET, or RDP (remote desktop protocol), an access port for such a protocol is statically set, and access is performed through the access port.

However, access is made through such a common default port, there is a problem of being vulnerable to hacking through port scanning or scanning using PING.

In particular, there has been a problem in that, after accessing a certain service server among a plurality of service servers, loop around connection is possible from the certain service server to another service server.

### DISCLOSURE

### Technical Problem

The present invention has been made in view of the above problems, and it is an object of the present invention to provide an information and communication service provision system capable of providing an information and communication service without exposing an address of a service server to a user through reverse connection using a dynamic port and a user network profile for a user using the service.

It is another object of the present invention to provide an information and communication service provision system which operates independently of existing security devices such as a firewall and VPN, and in which loop around connection from a certain service server to another service server is impossible.

It is a further object of the present invention to provide an information and communication service provision system capable of stably providing a service without interruption of the service even when a malfunction occurs in a proxy server in providing the service through a gateway including the proxy server.

### Technical Solution

To achieve the objects, an aspect of the present invention relates to a service provision system based on a user network profile, including a user terminal for a user to request a service and use the service provided from a service server, an access control server configured to provide the user network profile, which is information necessary to use the service, to the user, and to control access to the service server by the user, and a gateway configured to relay data provided from the service server to the user terminal between the user terminal and the service server, wherein the gateway includes an inspection unit configured to inspect operation states and access states of the user terminal and the service server in real time, and to selectively restrict service provision.

In the service provision system based on the user network profile according to an embodiment of the present invention, the gateway may include a first gateway for access to the user terminal, and a second gateway for access to the service server, and the second gateway may transmit, to the user terminal, data provided from the service server through a communication channel established from the second gateway to the first gateway.

In addition, data transmission between the first gateway and the second gateway may be performed exclusively in a reverse direction from the second gateway on a side of the service server to the first gateway on a side of the user terminal.

Further, the user terminal may request provision of the user network profile by transmitting authentication request information to the access control server, and the access control server may generate the user network profile based on the authentication request information and transmit the user network profile to the user terminal.

In addition, the authentication request information may include user information which is information on a user using the user terminal, device information which is unique information of the user terminal, and server access information which is information on access to the service server.

Further, the user network profile may include user authentication information (AuthToken) proving that the user is an authenticated user, device authentication information (DeviceToken) proving that the user terminal is an authenticated device, and server access authentication information (AccessToken) proving that the user is a user authorized to access the server.

In addition, the user authentication information (AuthToken) may be generated by being encoded using a user ID, an access time, and a unique value for each user.

Further, the device authentication information (DeviceToken) may be generated by being encoded using a device-specific ID.

In addition, the server access authentication information (AccessToken) may be generated by being encoded using a service ID, user information, an authentication time, and a unique key for each service server.

Further, the user terminal may request service usage from the first gateway based on the user network profile transmitted from the access control server, and the first gateway may request, from the access control server, authentication for the user network profile received from the user terminal.

In addition, the inspection unit may include a network inspection unit, a device inspection unit, and a service inspection unit.

Further, the network inspection unit may determine whether a network accessed by the user terminal is included in a preset allowed network, thereby determining whether the network is normal.

In addition, the device inspection unit may receive a device inspection result of a check program installed in the device and determine whether the device is normally operating.

Further, the service inspection unit may receive a service server inspection result by an inspection program of the service server and determine whether the service server is normally operating.

In addition, when a user network profile transmitted from the first gateway coincides with a user network profile previously transmitted to the user terminal, the access control server may be configured to set a first dynamic port and a second dynamic port in the first gateway and the second gateway, respectively, to establish a channel between the first gateway and the second gateway, and transmit, to the second gateway, an address and a port of a service server from which the service usage has been requested.

Further, the access control server may provide setting content of the first dynamic port and the second dynamic port to the second gateway.

In addition, the second gateway may request access to the service server using an address and a port of the service server provided by the access control server.

Further, the second gateway may access the first dynamic port of the first gateway using the second dynamic port.

In addition, the access control server may update and generate the first dynamic port or the second dynamic port periodically according to a preset condition.

Further, the preset condition may be new access of the user terminal.

In addition, the preset condition may be a capacity of data transmitted from the second dynamic port to the first dynamic port exceeding a preset data amount.

Further, when a service used by a specific user needs to be blocked, the access control server may release dynamic port setting of the second gateway.

In addition, the server access authentication information (AccessToken) may include an expiration time (ExpireDate), which is information about a server access validity time.

Further, according to a security level of the service server, the expiration time may be set to be shorter as the security level increases.

In addition, the user network profile may include validity information indicating whether the user network profile is valid.

Further, the validity information may be session information indicating an access session.

In addition, the validity information may include a limited data amount so that the access control server is allowed to discard the user network profile when a preset data capacity is provided according to an amount of data provided by the gateway to the user terminal.

Meanwhile, the present invention includes a user terminal for a user to request a service and use the service provided from a service server, an access control server configured to provide a one-time user access token including information necessary for the user to use the service and allowing the user terminal to access the service server for a unit session, and a proxy gateway configured to provide data provided from the service server to the user terminal between the user terminal and the service server, wherein the proxy gateway includes a proxy server for access to the user terminal, and a proxy agent for access to the service server, the proxy agent transmits data provided from the service server to the user terminal through a communication channel established from the proxy agent to the proxy server, and a plurality of proxy gateways is provided in parallel.

In this instance, it is possible to further include an access synchronization module configured to receive a one-time user access token from the access control server, and select and allocate a proxy gateway to be allocated to the user according to the one-time user access token.

Further, the communication channel established between the proxy agent and the proxy agent may include a plurality of data channels through which data provided from the service server is transmitted, and a control channel for transmitting control data for allocating the data channels to each user, and the control data may include a one-time user access token.

In addition, when an operational error is detected in any one of the proxy gateways, the access synchronization module may change and allocate an unoccupied data channel of a normally operating proxy gateway to users to whom a data channel of the proxy gateway from which the error is detected is allocated.

Further, the access synchronization module may allocate one or more of unoccupied data channels of the gateways as a spare channel according to a security level of the user among users to whom the data channels of the gateways are allocated.

In addition, data transmission between the proxy server and the proxy agent may be performed exclusively through a data channel established in a reverse direction from the proxy agent on a side of the service server to the proxy server on a side of the user terminal.

In addition, the authentication request information may include user information including a security level of a user using the user terminal, device information which is unique information of the user terminal, and server access information which is information on access to the service server.

Further, the access control server may transmit the generated one-time user access token to the access synchronization module, the access synchronization module may select any one of the proxy gateways and transmit the selected proxy gateway to a proxy agent of the proxy gateway, the proxy agent receiving the one-time user access token may transmit the one-time user access token to the proxy server through the control channel, the proxy server may set any one of the data channels and transmit set information to the access control server through the proxy agent, and the access control server may set a transmission channel of data to be provided from the service server for the user through the set information.

### Advantageous effects

The service provision system based on the user network profile according to the present invention provides only gateway information to the user through reverse connection with a dynamic port based on the network profile at the gateway that relays data between the user and the server, so that there is an effect that server information on the service being used is not exposed to the user, thereby completely blocking hacking.

In addition, in the present invention, multiple gateways configured as proxy servers are configured in parallel, so that even when a malfunction occurs in the proxy server, the service may be stably provided without service interruption.

In addition, according to the present invention, since the dynamic port of the first gateway on the user terminal side and the dynamic port of the second gateway on the service server side are updated and generated each time the user accesses the service server, there is an effect of being able to safely protect the gateway from hacking and information leakage.

In particular, according to the present invention, data transmission between the first gateway and the second gateway is performed only in a reverse direction from the second gateway on the service server side to the first gateway on the user terminal side, so that there is an effect of being able to fundamentally block external intrusion.

In addition, according to the present invention, through the use of the user network profile generated differently depending on conditions (time and session), even when information is exposed, the information becomes unusable after a period of time has passed, so that there is an effect of safeguarding server information.

In addition, there is an effect of selectively restricting service provision by inspecting operation states and access states of the user terminal and the service server in real time using an inspection unit.

### DESCRIPTION OF DRAWINGS

FIG. 1 is a block diagram of a service provision system based on a user network profile according to the present invention;

FIG. 2 is a block diagram illustrating an order of providing a service by the system of the present invention;

FIG. 3 is a conceptual diagram illustrating a configuration example of authentication request information and the user network profile according to the present invention;

FIG. 4 is a block diagram illustrating a flow of information for each device for providing the service according to the present invention;

FIG. 5 is a block diagram illustrating a configuration of a service provision system according to a second embodiment of the present invention;

FIG. 6 is a flowchart illustrating a flow of information for each device for providing a service according to the second embodiment of the present invention;

FIG. 7 is a block diagram illustrating a service provision system including devices for providing a service according to a third embodiment of the present invention;

FIG. 8 is a block diagram illustrating an order of providing the service for each device according to the third embodiment of the present invention;

FIG. 9 is a block diagram illustrating a configuration of a service provision system according to a fourth embodiment of the present invention;

FIG. 10 is a block diagram illustrating an order of a method of transmitting data for each device according to the fourth embodiment of the present invention; and

FIG. 11 is a block diagram illustrating a flow of data through a control channel according to the fourth embodiment of the present invention.

### BEST MODE

The present invention according to the best embodiments includes a user terminal for a user to request a service and use the service provided from a service server, an access control server configured to provide the user network profile, which is information necessary to use the service, to the user, and to control access to the service server by the user, and a gateway configured to relay data provided from the service server to the user terminal between the user terminal and the service server, wherein the gateway includes an inspection unit configured to inspect operation states and access states of the user terminal and the service server in real time, and to selectively restrict service provision.

### Mode for Invention

The present invention may be modified in various ways and may have various implementations, and specific embodiments are illustrated in the drawings and described in detail. However, this is not intended to limit the present invention to specific embodiments, and it should be understood that all modifications, equivalents, and substitutes included in the spirit and technical scope of the present invention are encompassed. In describing the present invention, when it is determined that a specific description of a related known technology may obscure the gist of the present invention, the detailed description thereof will be omitted.

The terms first, second, etc. may be used to describe various components, but the components should not be limited by the terms. The terms are used only to distinguish one component from another.

The present invention relates to a service provision system using a user network profile capable of preventing information exposure of a server through reverse connection with a dynamic port based on the user network profile at a gateway that relays data between a user and the server.

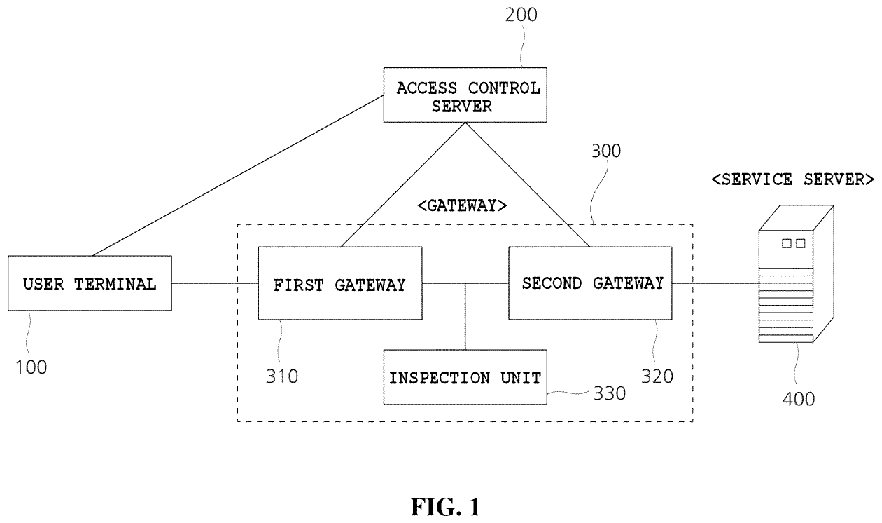

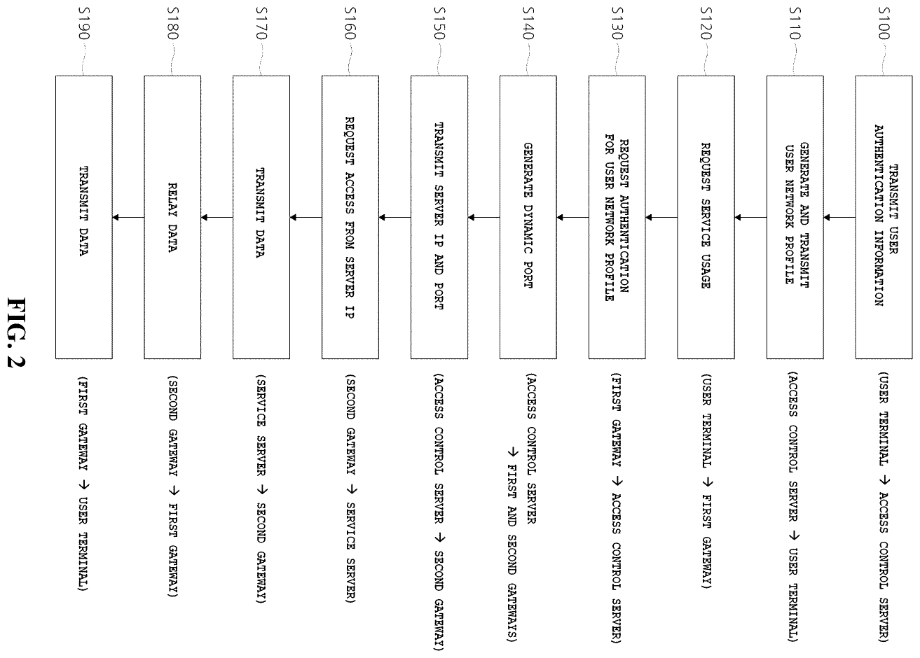

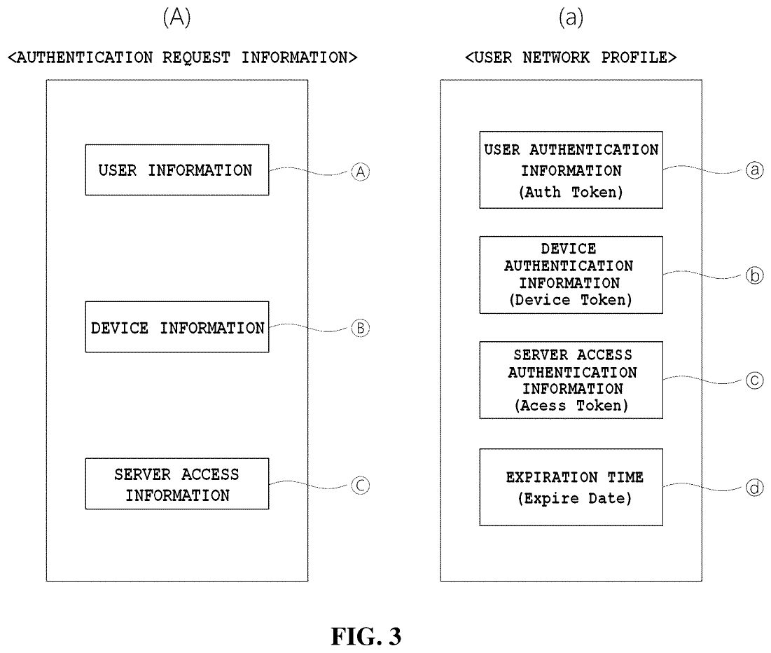

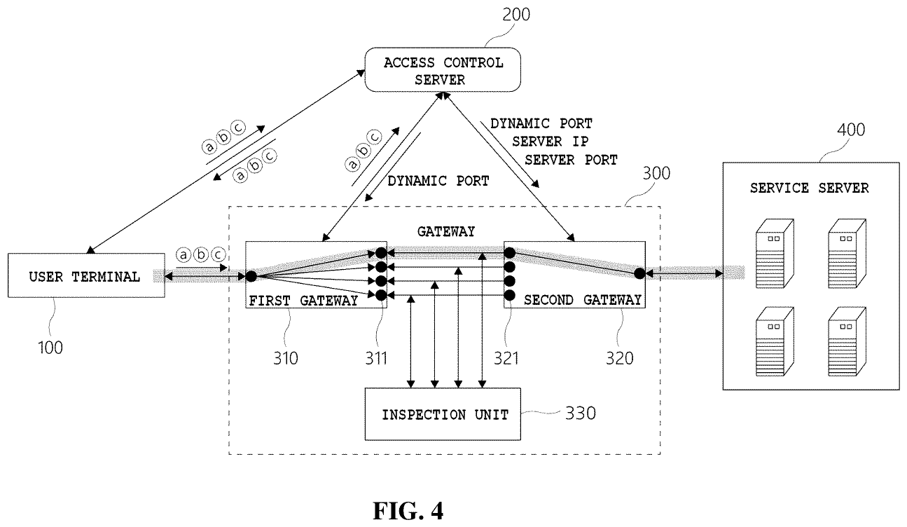

Hereinafter, a service provision system using a user network profile of the present invention will be described in more detail with reference to preferred embodiments and the attached drawings. In this regard, FIG. 1 is a block diagram of a service provision system using a user network profile according to the present invention, FIG. 2 is a block diagram illustrating an order of providing a service according to the present invention, FIG. 3 is a configuration diagram of authentication request information and the user network profile used in the present invention, and FIG. 4 is a block diagram illustrating a flow of information for each device for providing the service according to the present invention.

First, referring to FIG. 1, the service provision system using the user network profile of the present invention may broadly include a user terminal 100, an access control server 200, a gateway 300, and a service server 400.

The user terminal 100 is a device for a user to request a user network profile, which is authentication information for service usage qualification, by transmitting authentication request information to the access control server 200, and request a service from the gateway 300 when the service usage qualification is authenticated, to use a service provided from the service server 400. Examples of the user terminal 100 include a PC (Personal Computer) or a mobile phone, but are not limited thereto, and may include various information and communication devices capable of accessing a server of a service operator through a wired/wireless communication network.

The access control server 200 is a main server of the service operator and performs a function of generating a user network profile, which is information on service usage qualification required to request a service from the gateway 300, and providing the user network profile to the user terminal 100. Accordingly, access of the user to the service server 400 requiring security is controlled, and access to the gateway 300, such as connection request and connection termination for the gateway 300, is controlled.

The access control server 200 may include a database (not shown), and the database performs a function of storing and updating various data required for the system of the present invention to provide an information and communication service and providing the data to the access control server.

The gateway 300 may include a first gateway 310 for access to the user terminal 100 and a second gateway 320 for access to the service server 400.

Here, the system of the present invention is characterized by being configured so that data transmission between the first gateway 310 and the second gateway 320 is performed only in a reverse direction from the second gateway 320 on the service server 400 side to the first gateway 310 on the user terminal 100 side.

That is, data provided from the service server 400 is transmitted to the user terminal 100 by a communication channel formed from the second gateway 320 to the first gateway 310.

Therefore, according to the present invention, the gateway 300 excludes direct connection between the user terminal 100 and the service server 400, thereby preventing information about the service server 400 from being directly exposed to the user, while relaying data provided from the service server 400 to the user terminal 100. A detailed function of the gateway 300 will be described in more detail later.

The service server 400 is a server for providing a service desired to be used by the user, and may be configured to collectively include a plurality of servers requiring security depending on the type of service used by the user.

Hereinafter, a method of providing a service in the service provision system based on the user network profile according to the present invention will be described in more detail with reference to FIGS. 2 to 4.

In order to use the service of the present invention, first, the user transmits authentication request information to the access control server 200 using the user terminal 100 to request a user network profile, which is authentication information for service usage qualification (S100).

Next, the access control server 200 receiving the authentication request information authenticates information included in the authentication request information based on information in the database, generates a user network profile, and then transmits the user network profile to the user terminal (S110).

Here, the authentication request information necessary to request authentication to verify whether the user has the legitimate qualification to use the service may include user information A, which is personal information about the user using the user terminal 100, device information B, which is unique information about the user terminal 100, and server access information C, which is information about access to the service server 400.

The user information A may include, for example, information such as a name, an affiliation, and a position of the user. The device information B may include a unique device ID. In addition, the server access information C may include content of the service desired to be used by the user.

In the present invention, when the user has the legitimate qualification to use the service, the provided user network profile may include user authentication information (AuthToken) proving that the user is an authenticated user, device authentication information (DeviceToken) proving that the user terminal 100 is an authenticated device, and server access authentication information (AccessToken) proving that the user is a user authorized to access the server.

In this instance, the user authentication information (AuthToken) is generated in an encrypted form by being encoded using a user ID, an access time, and a unique value for each user.

Further, the device authentication information (DeviceToken) is generated in an encrypted form using a CPU ID, an HDD ID, a MAC Address, etc. in the case of a PC, and is generated in an encrypted form using a device-specific ID in the case of other devices.

In addition, the server access authentication information (AccessToken) is generated in an encrypted form by being encoded using a service ID, user information, an authentication time, and a unique key for each service server.

Accordingly, according to the present invention, since access is possible only when information about users, servers, and terminals is transmitted and received in an encrypted form, and an authenticated user (AuthToken) has authority to access (AccessToken) the server from an authenticated device (DeviceToken), it is possible to fundamentally block a user without service usage qualification from accessing the server.

Hereinafter, a description will be given of a step in which a user whose service usage qualification is authenticated requests a request, receives data, and uses a service.

First, the user receiving the user network profile as described above uses the user terminal 100 to transmit the user network profile to the first gateway 310, thereby requesting a service (S120).

As described above, when the user requests a service from the first gateway 310 using the user terminal 100, the first gateway 310 first transmits the user network profile received from the user terminal 100 to the access control server 200 to request authentication for the user network profile (S130).

As described above, the access control server 200 receiving the user network profile performs authentication therefor. That is, when the received user network profile coincides with the user network profile previously transmitted to the user terminal 100, the access control server 200 sets a first dynamic port 311 in the first gateway 310 and sets a second dynamic port 321 in the second gateway 320 (S140).

In this instance, the access control server 200 provides setting content of the first dynamic port 311 and the second dynamic port 321 to the second gateway 320, so that connection is established from the second dynamic port 321 of the second gateway 320 to the first dynamic port 311 of the first gateway 310. At the same time, the access control server 200 transmits an address and a port of a service server, from which the service usage has been requested, to the second gateway 320 (S150).

Here, the first dynamic port 311 refers to a variable port for access to the user terminal 100 side, and the second dynamic port 321 refers to a variable port for access to the service server 400 side.

Then, the second gateway 320 requests connection from the service server 400 using the address of the service server transmitted from the access control server 200 (S160). Thereafter, when access to the service server 400 is made using the server address, the service server 400 transmits data to the second gateway 320 (S170).

In this instance, the second gateway 320 receives data through the second dynamic port 321 and relays the received data to the first dynamic port 311 of the first gateway 310 (S180). In addition, the first gateway 310 transmits the data received through the first dynamic port 311 to the user terminal 100 (S190), thereby providing a service.

According to an embodiment of the present invention, the access control server 200 may update and generate the first dynamic port 311 or the second dynamic port 321 periodically according to a preset condition.

For example, the access control server 200 may newly generate the first dynamic port 311 or the second dynamic port 321 each time the user terminal 100 accesses the access control server 200. Therefore, since a separate dynamic port is used each time the user terminal 100 accesses the server, the gateway 300 may be safely protected by blocking hacking and information leakage.

In addition, the preset condition may be a case where a capacity of data transmitted from the second dynamic port 321 to the first dynamic port 311 exceeds a preset data amount. That is, since a new dynamic port is generated and data is transmitted after the user receives a predetermined amount of data, even when the existing port information is leaked, the port information cannot be continuously used.

In this instance, when a service used by a specific user needs to be blocked, the access control server 200 may release the dynamic port setting of the second gateway 320 to stop data transmission. In this way, it is possible to control abnormal access.

Therefore, according to the present invention, since the data provided by the service server 400 is only transmitted through the gateway 300, instead of being directly transmitted to the user terminal 100, only information of the gateway 300 is provided to the user, so that server information about the service being used is not exposed to the user, and thus hacking may be completely blocked.

In particular, since the present invention updates and generates the first dynamic port 311 of the first gateway 310 and the second dynamic port 321 of the second gateway 320 according to a preset condition, the gateway may be safely protected from hacking and information leakage. In addition, even when the port information is leaked, the port information cannot be continuously used.

In this instance, data transmission between the first gateway 310 and the second gateway 320 is performed only in the reverse direction from the second gateway 320 on the service server side to the first gateway 310 on the user terminal side, and thus it is possible to fundamentally block external intrusion.

According to an embodiment of the present invention, the gateway 300 may include an inspection unit 330 that inspects operation states and access states of the user terminal and the service server in real time and selectively restricts service provision.

In this instance, the inspection unit 330 may include a network inspection unit, a device inspection unit, and a service inspection unit. The network inspection unit may determine whether a network accessed by the user terminal is included in a preset allowed network, thereby determining whether the network is normal.

In addition, the device inspection unit may receive a device inspection result of a check program installed in the device and determine whether the device is normally operating. In addition, the service inspection unit may receive a service server inspection result by an inspection program of the service server and determine whether the service server is normally operating.

Accordingly, according to the present invention, the operation states and the access states of the user terminal and the service server may be inspected in real time through the inspection unit 330 to selectively restrict service provision.

According to another embodiment of the present invention, the server access authentication information of the user network profile may include an expiration time (ExpireDate), which is information about a server access validity time.

Therefore, the service is used for a permitted time by controlling an expiration time when using the service. Thus, even when information is exposed, only temporary use is possible due to continuous change.

In particular, according to this embodiment, according to a security level of the service server 400, the expiration time may be set to be shorter as the security level increases. For example, when accessing a server where confidentiality is important and using the service, a service usage time may be set to be short and a user authentication procedure may be frequently performed, so that it is possible to minimize information leakage from the service server 400 where security is important.

According to another embodiment of the present invention, the user network profile may include validity information indicating whether the user network profile is valid.

In this instance, the validity information may be session information indicating an access session. The session information may be newly set and updated, for example, each time the user accesses the access control server 200.

In addition, the validity information may include a limited data amount so that the access control server 200 may discard the corresponding user network profile when a preset data capacity is provided according to the amount of data provided by the gateway 300 to the user terminal 100. In other words, after the user receives predetermined data, connection is interrupted, and the user needs to input new authentication request information to continue the connection.

Accordingly, according to the present invention, since access to the server is controlled using a user network profile that is differently generated according to conditions (time, data amount, and session), even when server information is exposed, it becomes impossible to access the server when a set condition, i.e., a set time, data volume, or session has elapsed. Therefore, continuous use is impossible even when the server information is temporarily exposed.

Hereinafter, a specific configuration of a service provision system based on a user network profile according to a second embodiment of the present invention will be described with reference to the attached drawings. However, in describing the second embodiment of the present invention, a description of redundant technical content identical to that of the above-described embodiment will be omitted.

The service provision system based on the user network profile according to the second embodiment of the present invention is a service provision system that prevents information exposure of a server through reverse connection with a dynamic port based on a one-time user access token at a gateway that provides data between a user and the server, and ensures stability of service provision through multiple proxy servers combined in parallel.

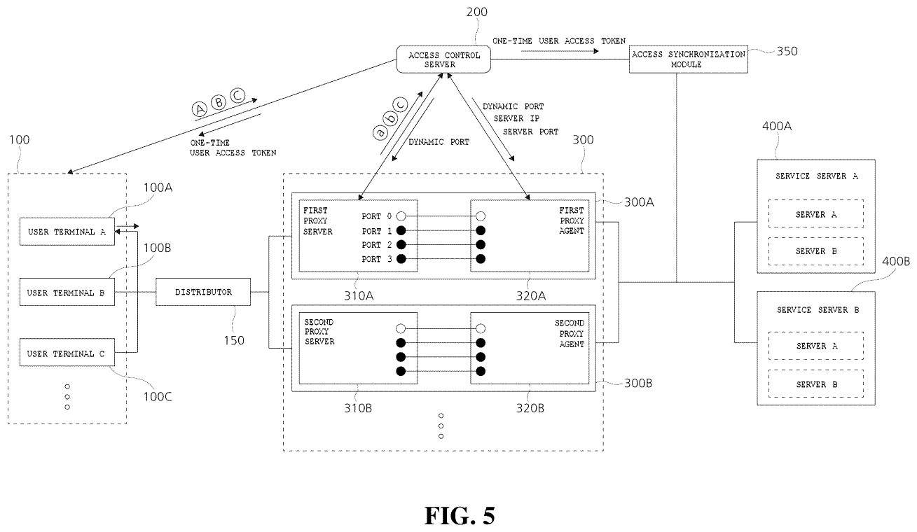

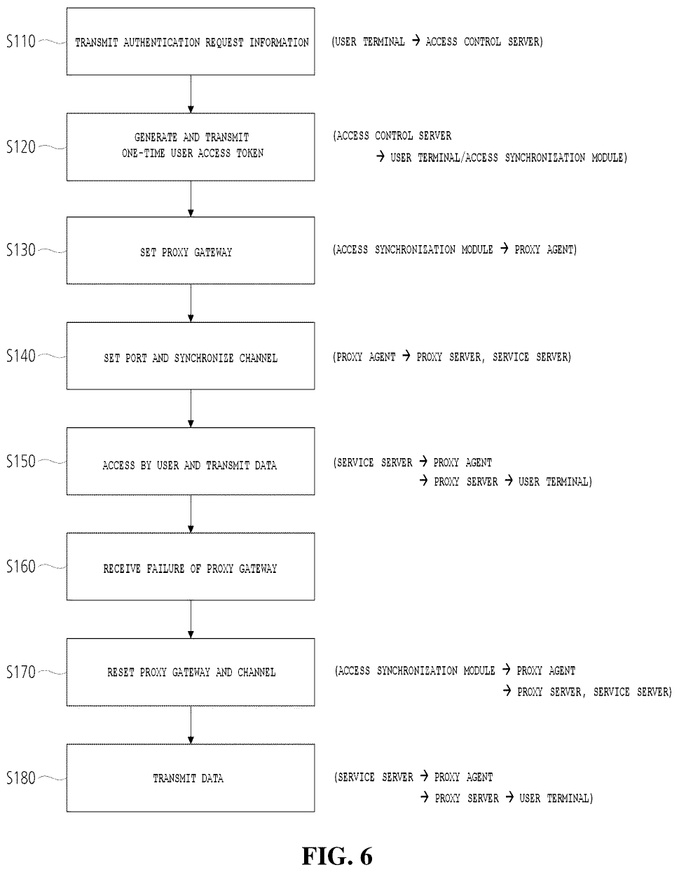

To this end, as illustrated in FIGS. 5 and 6, the service provision system based on the user network profile according to the second embodiment of the present invention may broadly include a user terminal 100, an access control server 200, a proxy gateway 300, a service server 400, and a database 500.

The user terminal 100 is a device for a user to request a one-time user access token, which is authentication information for service use qualification, by transmitting authentication request information to the access control server 200, request a service from the proxy gateway 300 when the service use qualification is authenticated, and use the service provided from the service server 400.

In this embodiment, the one-time user access token means a user profile that is generated once, and user access token and user profile are used interchangeably.

The access control server 200 is a main server of a service operator and performs a function of generating a one-time user access token, which is information on service usage qualification required to request a service from the proxy gateway 300, and providing the one-time user access token to the user terminal 100. Accordingly, access of the user to the service server 400 requiring security is controlled, and access of the proxy gateway 300, such as connection request and connection termination of the proxy gateway 300, is controlled.

The access control server 200 may be configured in conjunction with the database 500, and the database 500 performs a function of storing and updating various data required for the system of the present invention to provide the information and communication service and providing the data to the access control server 200.

The proxy gateway 300 may include a proxy server 310 for accessing the user terminal 100 and a proxy agent 320 for accessing the service server 400.

In this instance, the proxy server 310 and the proxy agent 320 are configured to correspond to the first gateway and the second gateway, respectively.

Further, the system of the present invention is configured so that data transmission between the proxy server 310 and the proxy agent 320 is performed only in a reverse direction from the proxy agent 320 on the service server 400 side to the proxy server 310 on the user terminal 100.

That is, data provided from the service server 400 is transmitted to the user terminal 100 by a data channel formed from the proxy agent 320 to the proxy server 310.

Accordingly, according to the present invention, the proxy gateway 300 excludes direct connection between the user terminal 100 and the service server 400, thereby preventing information about the service server 400 from being directly exposed to the user, while providing data provided from the service server 400 to the user terminal 100. In a specific configuration of the proxy gateway 300, a plurality of proxy gateways may be provided as illustrated in FIG. 5.

In addition, an access synchronization module 350 is provided to receive a one-time user access token from the access control server 200, and select and allocate a proxy gateway 300 to be allocated to a user according to the one-time user access token.

That is, the access synchronization module 350 selects one of proxy gateways 300 having an unoccupied data channel among the proxy gateways 300 and allocates the proxy gateway to the user.

Meanwhile, the proxy gateway 300 includes the proxy server 310 and the proxy agent 320, and a communication channel including one control channel (port 0) and a plurality of data channels (ports 1, 2, . . . ) is formed between the proxy server 310 and the proxy agent 320.

In this instance, the data channel is a channel through which data provided from the service server 400 is transmitted, and is allocated to a user by the proxy server 310 and used as a channel through which the user receives data from the service server 400.

Further, the control channel is a channel for transmitting control data for allocating the data channel to each user, and is a channel that typically receives a one-time user access token provided by the proxy agent 320 and transmits setting content of the data channel set by the proxy server 310 for the user to the proxy agent 320.

Meanwhile, the access synchronization module 350 allocates a new proxy gateway 300 to a user using the corresponding proxy gateway 300 when an operational error is detected in any one of the proxy gateways 300.

That is, when an operational error is detected in the proxy gateway 300, the access synchronization module 350 reallocates an unoccupied data channel of a normally operating proxy gateway 300 to the corresponding user so that the corresponding user may continue to receive a service from the service server.

Furthermore, the access synchronization module 350 may allocate a spare data channel to the user in preparation for an operational error of the proxy gateway 300.

In this instance, considering physical limitations of data channels, a spare data channel may be allocated to a user having a high security level. The security level may be a security level of the user acquired from user authentication information or a device security level acquired from device authentication information.

That is, the access synchronization module 350 may allocate one or more unoccupied data channels of the proxy gateway 300 as spare channel(s) according to a security level of the user among users to whom the data channels of the proxy gateway 300 are allocated.

Accordingly, in the case of a user having a high security level, even when an operation error of the proxy gateway 300 occurs while receiving a service from the service server, the service may be continuously provided without service interruption.

Meanwhile, the service server 400 is a server for providing a service desired to be used by the user, and a plurality of servers requiring security may be collectively configured according to a type of service used by the user.

In addition, a distributor 150 performs a function of connecting the user terminal 100 to the proxy server 310 where the data channel is set for the user terminal 100 when there is a service request from the user terminal 100 in a state in which a data channel is allocated to each user in the proxy server 310.

Hereinafter, a method of providing a service according to the second embodiment of the present invention will be described in more detail with reference to FIGS. 5 and 6.

In order to use the service of the present invention, as illustrated in FIG. 6, first, the user transmits authentication request information to the access control server 200 using the user terminal 100 to request a one-time user access token, which is authentication information for service usage qualification (S110).

Next, the access control server 200 receiving the authentication request information authenticates the information included in the authentication request information based on the information in the database 500, generates a one-time user access token, and then transmits the one-time user access token to the user terminal 100 and the access synchronization module 350 (S120).

Here, the authentication request information required to request authentication on whether the user has a legitimate qualification to use the service may include user information A, which is personal information about the user using the user terminal 100, device information B, which is unique information about the user terminal 100 device, and server access information C, which is information about access to the service server 400.

In the present invention, the one-time user access token provided when the user has a legitimate qualification to use the service may include user authentication information (AuthToken) proving that the user is an authenticated user, device authentication information (DeviceToken) proving that the user terminal 100 is an authenticated device, server access authentication information (AccessToken) proving that the user is a user authorized to access the server, and valid period authentication information (EffectiveToken) proving that the one-time user access token is a valid token.

Meanwhile, the valid period authentication information (EffectiveToken) may be information on an elapsed time after issuance that limits validity of the one-time user access token after a preset time by counting the preset time during issuance of the one-time user access token.

Thereafter, the access synchronization module 350 receiving the one-time user access token from the access control server 200 selects a proxy gateway 300 having an unoccupied data channel among the proxy gateways 300, and transmits the one-time user access token to a proxy agent of the corresponding proxy gateway (S130).

Then, the proxy agent 320 receiving the one-time user access token transmits the one-time user access token to the proxy server 310 through the control channel, and the proxy server 310 sets one of the data channels and transmits the set information to the access control server 350 through the proxy agent 320, thereby completing setting of the proxy gateway 300 and the data channel thereof for the corresponding user (S140).

Thereafter, data requested from the service server is provided to the user terminal through the proxy gateway 300 and the data channel set according to the request from the user (S150).

Meanwhile, when a failure occurs (an operational error is detected) in a specific proxy gateway 300, a new proxy gateway 300 is allocated to a user terminal using a data channel of the proxy gateway 300 (S160 and S170).

Specifically, in this case, when an operational error is detected in the proxy gateway 300, the access synchronization module 350 reallocates an unoccupied data channel of a normally operating proxy gateway 300 to the user.

Then, data from the service server is provided to the user terminal 100 through the reallocated proxy gateway 300 and the data channel thereof (S180).

Accordingly, even when a specific proxy gateway 300 fails, the service may be stably provided to the user without service interruption.

Meanwhile, although not illustrated, the access control server 200 may generate a transmission channel of data set for the user by periodically updating the transmission channel according to a preset condition in order to enhance security.

In addition, when it is necessary to block a service used by a specific user, the access control server 200 may release a channel set for the user and stop data transmission. In this way, it is possible to control abnormal access.

In this way, according to the present invention, since the data provided by the service server 400 is only transmitted through the proxy gateway 300 without being directly transmitted to the user terminal 100, only the proxy gateway 300 information is provided to the user, so that server information on the used service is not exposed to the user, and thus hacking may be completely blocked.

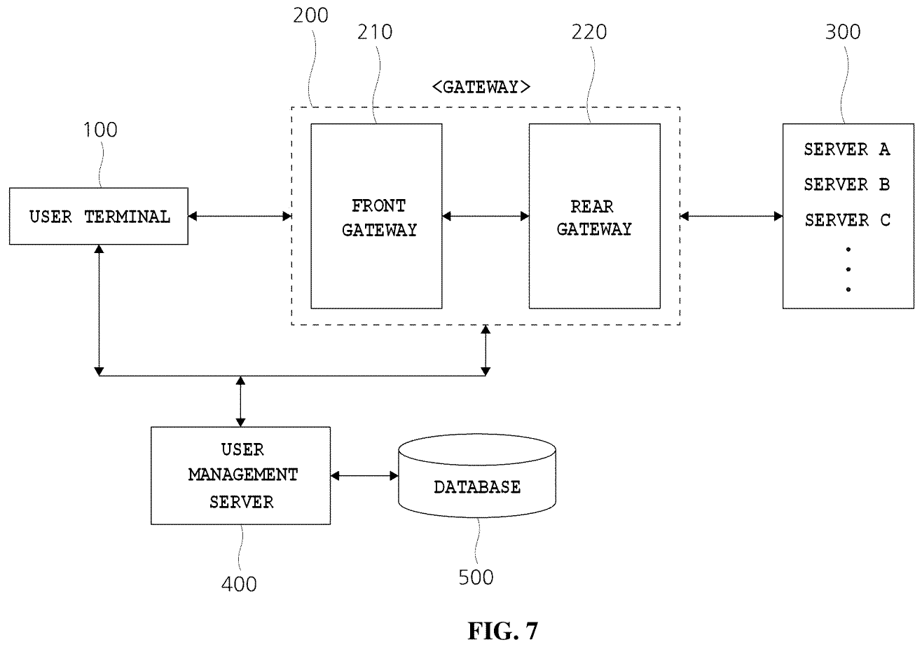

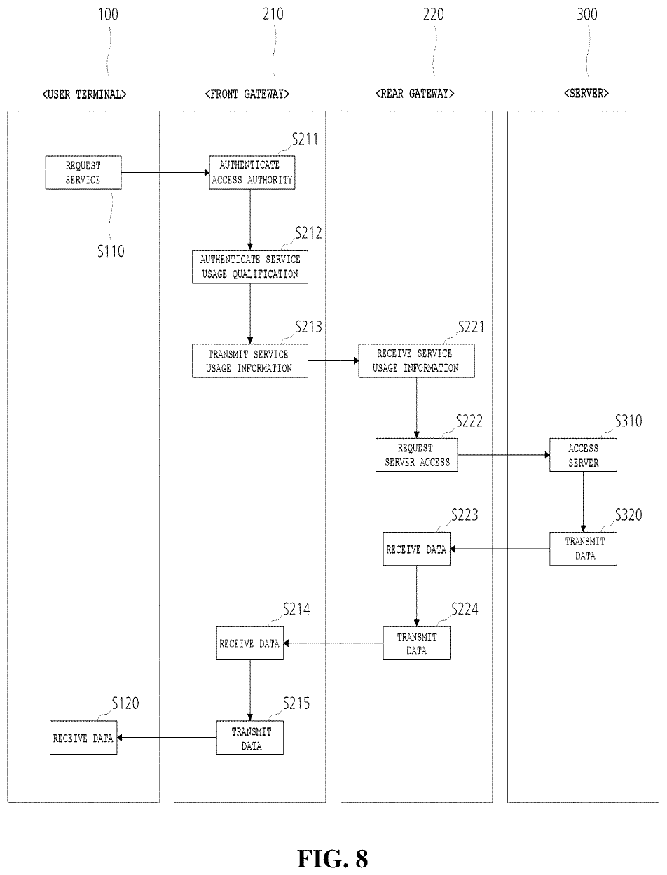

Hereinafter, a method of providing a service according to a third embodiment of the present invention will be described in more detail with reference to FIGS. 7 and 8.

As illustrated in FIG. 8, the method of providing the service according to the third embodiment of the present invention may include a step (A) of requesting, by the user terminal, a service for the server 300 from the front gateway 210, an access authority authentication step (B) of determining, by the front gateway 210, whether the user terminal requesting the service is qualified to access the gateway, a service usage qualification authentication step (C) of determining, by the front gateway 210, whether the user terminal authenticated to have the access authority is qualified to use the service for the server 300, a step (D) of requesting, by the gateway, the service from the server 300, and a step (E) of relaying, by the rear gateway 220, a service provided from the server 300 and providing the service to the user terminal through the front gateway 210.

First, when the user terminal 100 transmits service request information to the front gateway 210 to request a service for the server 300, the front gateway 210 performs an access authority authentication step to determine whether the user requesting the service is qualified to access the gateway 200 and a service usage qualification authentication step to determine whether the user terminal 100 is qualified to use the service for the server 300.

Here, the access authority authentication is performed based on an access profile 211 generated by the user management server 400. In this instance, the access profile 211 may include information about access computer information, a user account, a session duration, and a user access address.

That is, when the information included in the service request information transmitted from the user terminal 100 coincides with the information included in the access profile 211, which is the access computer information, the user account, the session duration, and the user access address, access between the user terminal 100 and the front gateway 210 is maintained.

Next, when it is recognized that the user is qualified to access the gateway 200, the front gateway 210 performs service usage qualification authentication to determine whether the user is qualified to use the service.

The service usage qualification authentication is performed based on the service profile 212 generated by the user management server 400. In this instance, the service profile 212 may include information on a service name, a protocol, an IP address, a port number, a permission command, and a blocking command.

That is, the information included in the service request information transmitted from the user terminal 100 is compared with the information included in the service profile 212, which is the information on the service name, the protocol, the IP address, the port number, the permission command, and the blocking command, to determine whether the user is qualified to use the service.

In this instance, when the service request information includes the permission command, access to the rear gateway 220 is executed, and when the blocking command is included, access to the rear gateway 220 is not executed.

In this way, when the user terminal 100, i.e., the user, is authenticated as being qualified to use the service, the front gateway 210 transmits the service request information received from the user terminal 100 to the rear gateway 220. Then, the rear gateway 220 transmits the service request information to the server 300, thereby executing access to the server 300.

When access between the rear gateway 220 and the server 300 is executed in this way, the rear gateway 220 receives the service provision information transmitted from the server 300, and then transmits the service provision information to the front gateway 210, and the front gateway 210 transmits the service provision information to the user terminal 100, thereby executing the service from the server 300.

In this instance, when the blocking command is included in the service request information received from the front gateway 210 while performing the service, access between the rear gateway 220 and the server 300 is blocked.

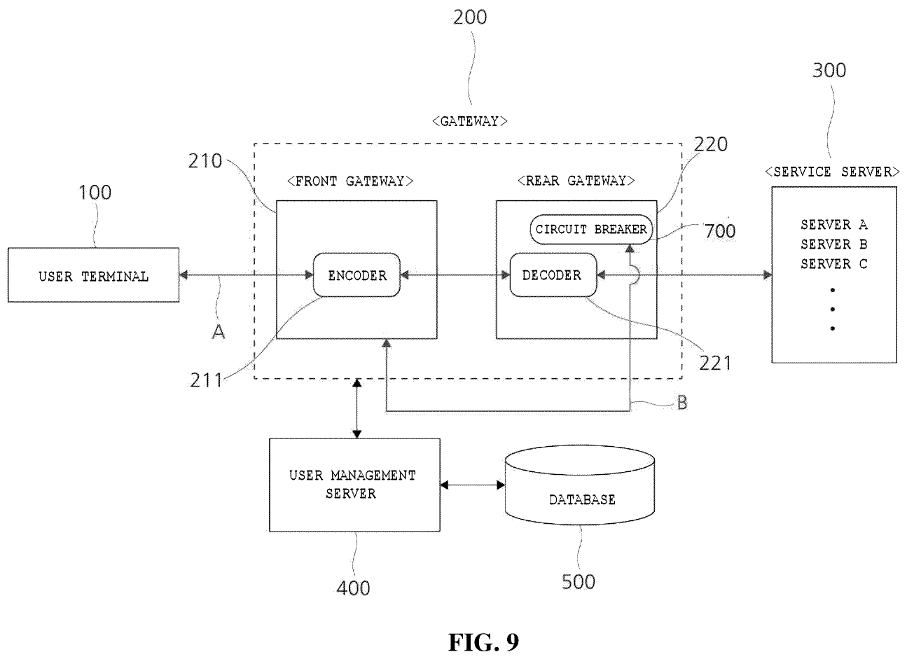

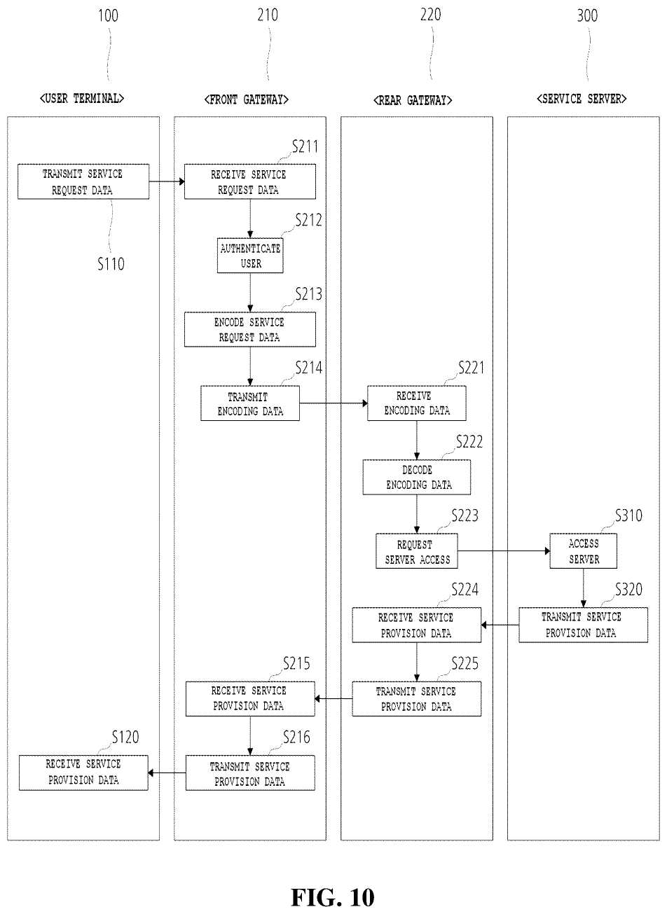

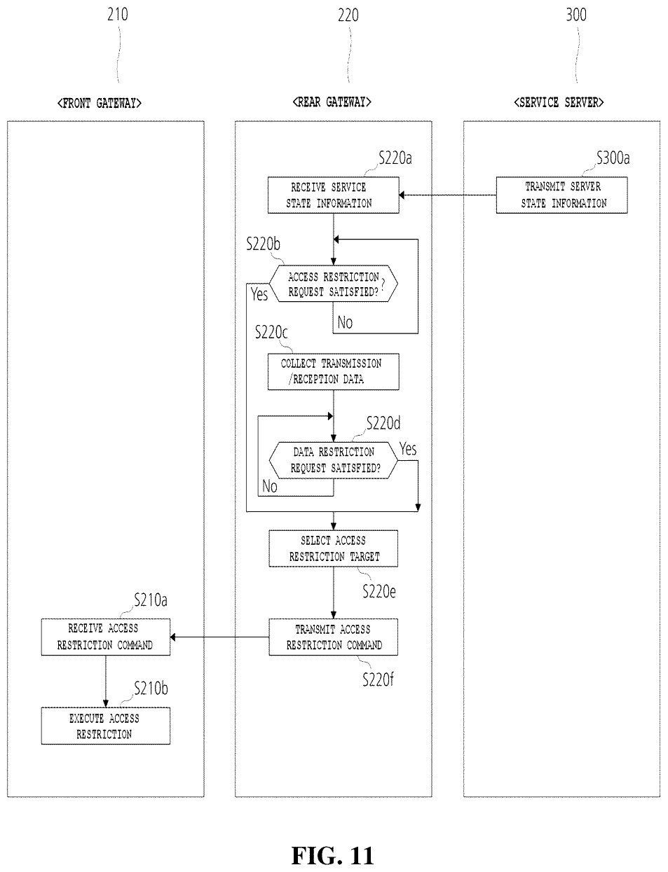

Next, a method of providing a service according to a fourth embodiment of the present invention will be described in more detail below with reference to FIGS. 9 to 11.

In the method of providing the service according to the fourth embodiment of the present invention, as illustrated in FIGS. 9 to 11, the gateway 200 serves to perform a function of relaying data provided from the server 300 to the user terminal 100 while preventing information about the server 300 from being directly exposed to the user by excluding direct connection between the user terminal 100 and the server 300.

In the present invention, the gateway 200 includes a front gateway (front access gateway) 210 that performs access and authentication functions with respect to the user terminal 100 and a rear gateway (back access gateway) 220 that performs a connection function with respect to the server. In this instance, the front gateway 210 includes an encoder 211, and the rear gateway 220 includes a decoder 221 and a circuit breaker 700.

In addition, the service server 300 is a server for providing a service desired to be used by the user, and a plurality of servers requiring security may be collectively configured according to a type of service used by the user.

The user management server (API/Management Server) 400 is a server connected to the gateway 200 and a database 500 to manage information about the user, performs a function of generating and changing a user network profile 600 described below, and manages data required therefor.

The database 500 stores and updates various data required to provide the service of the present invention and performs a function of providing the data to the user management server 400.

A method of transmitting data according to the fourth embodiment of the present invention processes data by separating a transmission channel for data into two channels, namely, a control channel B and an information channel A, when processing the data, thereby restricting access to the control channel B from the outside and further strengthening security of the server.

That is, according to the present invention, data processed in the present invention is divided into control data and information data according to an execution function of the data, and the control data and the information data are separately transmitted through the control channel B and the information channel A, respectively.

In this instance, the control data may include data related to connection state setting of the user terminal 100 and the service server 300, data including operation state information of the service server 300, and data related to data transmission blocking and data inspection.

In addition, the information data may include data including service request content of the user terminal 100 and data including service content provided by the service server 300.

Accordingly, according to the present invention, data related to general information content between the user terminal 100 and the service server 300 is transmitted through the information channel A, and data related to access between the user terminal 100 and the service server 300 is transmitted through the control channel B, thereby preventing information about the service server 300 from being leaked to the outside.

Even though the preferred embodiments of the present invention have been described above, those with common knowledge in the relevant technical field will be able to modify and change the present invention in various ways by adding, changing, deleting or adding components within the scope not deviating from the spirit of the present invention described in the patent claims, and this will also be encompassed within the scope of the rights of the present invention.

### INDUSTRIAL APPLICABILITY

The present invention relates to a service provision system based on a user network profile capable of providing a service without exposing an address of a service server through reverse connection with a dynamic port based on the user network profile at a gateway that relays data between a user and the server. According to the present invention, data transmission between a first gateway and a second gateway is performed only in a reverse direction from the second gateway on a service server side to the first gateway on a user terminal side, thereby having an effect of being able to fundamentally block external intrusion.

1. A service provision system based on a user network profile, the service provision system comprising:
a user terminal for a user to request a service and use the service provided from a service server;
an access control server configured to provide the user network profile, which is information necessary to use the service, to the user, and to control access to the service server by the user; and
a gateway configured to relay data provided from the service server to the user terminal between the user terminal and the service server, wherein:
the gateway comprises an inspection unit configured to inspect operation states and access states of the user terminal and the service server in real time, and to selectively restrict service provision,
the gateway comprises:
a first gateway for access to the user terminal; and
a second gateway for access to the service server,
the second gateway transmits, to the user terminal, data provided from the service server through a communication channel established from the second gateway to the first gateway,
data transmission between the first gateway and the second gateway is performed exclusively in a reverse direction from the second gateway on a side of the service server to the first gateway on a side of the user terminal,
the user terminal requests provision of the user network profile by transmitting authentication request information to the access control server,
the access control server generates the user network profile based on the authentication request information and transmits the user network profile to the user terminal,
the authentication request information comprises:
user information which is information on a user using the user terminal;
device information which is unique information of the user terminal; and
server access information which is information on access to the service server,
the user network profile comprises:
user authentication information (AuthToken) (proving that the user is an authenticated user;
device authentication information (DeviceToken) proving that the user terminal is an authenticated device; and
server access authentication information (AccessToken) proving that the user is a user authorized to access the server,
the server access authentication information (AccessToken) is generated by being encoded using a service ID, user information, an authentication time, and a unique key for each service server,
the user terminal requests service usage from the first gateway based on the user network profile transmitted from the access control server,
the first gateway requests, from the access control server, authentication for the user network profile received from the user terminal,
the server access authentication information (AccessToken) comprises an expiration time (ExpireDate) which is information on a server access validity time, wherein, according to a security level of the service server, the expiration time is set to be shorter as the security level increases,
the user network profile comprises validity information indicating whether the user network profile is valid, and
the validity information comprises a limited data amount so that the access control server is allowed to discard the user network profile when a preset data capacity is provided according to an amount of data provided by the gateway to the user terminal.

2. The service provision system according to claim 1, wherein:
the user authentication information (AuthToken) is generated by being encoded using a user ID, an access time, and a unique value for each user;
the device authentication information (DeviceToken) is generated by being encoded using a device-specific ID; and
the server access authentication information (AccessToken) is generated by being encoded using a service ID, user information, an authentication time, and a unique key for each service server.

3. The service provision system according to claim 2, wherein the inspection unit comprises:
a network inspection unit;
a device inspection unit; and
a service inspection unit.

4. The service provision system according to claim 1, wherein, when a user network profile transmitted from the first gateway coincides with a user network profile previously transmitted to the user terminal, the access control server is configured to:
set a first dynamic port and a second dynamic port in the first gateway and the second gateway, respectively, to establish a channel between the first gateway and the second gateway, and
transmit, to the second gateway, an address and a port of a service server from which the service usage has been requested.

5. The service provision system according to claim 4, wherein the validity information is session information indicating an access session.

6. The service provision system according to claim 5, wherein the validity information comprises a limited data amount so that the access control server is allowed to discard the user network profile when a preset data capacity is provided according to an amount of data provided by the gateway to the user terminal.

7. A service provision system based on a user network profile, the service provision system comprising:
a user terminal for a user to request a service and use the service provided from a service server;
an access control server configured to provide a one-time user access token including information necessary for the user to use the service and allowing the user terminal to access the service server for a unit session; and
a proxy gateway configured to provide data provided from the service server to the user terminal between the user terminal and the service server, wherein:
the proxy gateway comprises:
a proxy server for access to the user terminal; and
a proxy agent for access to the service server,
the proxy agent transmits data provided from the service server to the user terminal through a communication channel established from the proxy agent to the proxy server, and
a plurality of proxy gateways is provided in parallel.

8. The service provision system according to claim 7, further comprising an access synchronization module configured to receive a one-time user access token from the access control server, and select and allocate a proxy gateway to be allocated to the user according to the one-time user access token.

9. The service provision system according to claim 8, wherein:
the communication channel established between the proxy agent and the proxy server comprises:
a plurality of data channels through which data provided from the service server is transmitted; and
a control channel for transmitting control data for allocating the data channels to each user, and
the control data comprises a one-time user access token.

10. The service provision system according to claim 9, wherein, when an operational error is detected in any one of the proxy gateways, the access synchronization module changes and allocates an unoccupied data channel of a normally operating proxy gateway to users to whom a data channel of the proxy gateway from which the error is detected is allocated.

11. The service provision system according to claim 7, wherein the one-time user access token comprises:
user authentication information (AuthToken) proving that the user is an authenticated user;
device authentication information (DeviceToken) proving that the user terminal is an authenticated device;
server access authentication information (AccessToken) proving that the user is a user authorized to access the server; and
valid period authentication information (EffectiveToken) proving that the one-time user access token is a valid token.

12. The service provision system according to claim 11, wherein data transmission between the proxy server and the proxy agent is performed exclusively through a data channel established in a reverse direction from the proxy agent on a side of the service server to the proxy server on a side of the user terminal.

13. The service provision system according to claim 12, wherein:
the user terminal transmits authentication request information to the access control server to request provision of a one-time user access token, and
the access control server generates a one-time user access token based on the authentication request information and transmits the one-time user access token to the user terminal.

14. The service provision system according to claim 13, wherein the authentication request information comprises:
user information including a security level of a user using the user terminal;
device information which is unique information of the user terminal; and
server access information which is information on access to the service server.

15. The service provision system according to claim 14, wherein:
the access control server transmits the generated one-time user access token to the access synchronization module;
the access synchronization module selects any one of the proxy gateways and transmits the selected proxy gateway to a proxy agent of the proxy gateway;
the proxy agent receiving the one-time user access token transmits the one-time user access token to the proxy server through the control channel;
the proxy server sets any one of the data channels and transmits set information to the access control server through the proxy agent; and
the access control server sets a transmission channel of data to be provided from the service server for the user through the set information.

16. The service provision system according to claim 15, wherein the access control server updates and generates a transmission channel of set data periodically according to a preset condition.

17. The service provision system according to claim 16, wherein the preset condition is a capacity of data transmitted through the proxy gateway exceeding a preset data amount.

18. The service provision system according to claim 17, wherein the server access authentication information (AccessToken) comprises an expiration time (ExpireDate) which is information on a server access validity time.

19. The service provision system according to claim 18, wherein the user network profile comprises validity information indicating whether the user network profile is valid.
